(19) United States
(12) Patent Application Publication
(10) Pub. No.: US 2008/0271304 A1
(43) Pub. Date: Nov. 6, 2008

(54) Machine Tool

(75) Inventor: Walter Grossmann, Baltmannsweiler (DE)

Correspondence Address: REINHART BOERNER VAN DEUREN P.C., 2215 PERRYGREEN WAY, ROCKFORD, IL, 61107, US

(73) Assignee: Index-Werke Gmbh & Co. KG Hahn & Tessky, Esslingen (DE)

(21) Appl. No.: 12/175,202

(22) Filed: Jul. 17, 2008

Related U.S. Application Data
(63) Continuation of application No. PCT/EP2007/000324, filed on Jan. 16, 2007.

(30) Foreign Application Priority Data
Jan. 20, 2006 (DE) 10 2006 003 985.8

(51) Int. Cl. B23Q 7/00; B23Q 1/01

(52) U.S. Cl. 29/561

(57) ABSTRACT

In order to improve a machine tool comprising a machine frame with a machine bed, machining units mounted on the machine bed, of which at least one is a work spindle for a workpiece to be machined and at least one is a tool carrier, displacement units, by which the at least one work spindle and the at least one tool carrier can be moved relative to one another within a working space for machining the workpiece, and a handling device, by which workpieces can be inserted into and removed from the work spindle, in such a way that the time during which the tools are in the working space can be optimized, and consequently the times for machining each of the workpieces can also be optimized, it is proposed that a wall defining the working space being provided with an opening, by the handling device being disposed on a side of the opening that is remote from the working space and by it being possible to use the handling device to insert workpieces into the work spindle and/or remove them from it through the opening.

### CROSS REFERENCE TO RELATED APPLICATIONS

This application is a continuation of International application No. PCT/EP2007/000324 filed on Jan. 16, 2007.

This patent application claims the benefit of International application No. PCT/EP2007/000324 of Jan. 16, 2007 and German application No. 10 2006 003 985.8 of Jan. 20, 2006, the teachings and disclosure of which are hereby incorporated in their entirety by reference thereto.

### BACKGROUND OF THE INVENTION

The invention relates to a machine tool comprising a machine frame with a machine bed, machining units mounted on the machine bed, of which at least one is a work spindle for a workpiece to be machined and at least one is a tool carrier, displacement units, by which the at least one work spindle and the at least one tool carrier can be moved relative to one another within a working space for machining the workpiece, and a handling device, by which workpieces can be inserted into and removed from the work spindle.

Machine tools of this type are known from the prior art. In the case of these machine tools, the insertion and removal of workpieces into and from the work spindle is performed by means of a handling device disposed in the working space.

A handling device of this type, disposed in the working space, has the disadvantage that the handling of the workpieces in the working space takes up periods of time that are no longer available for the machining of the workpiece.

It is therefore an object of the invention to improve a machine tool of the generic type in such a way that the time during which the tools are in the working space can be optimized, and consequently the times for machining each of the workpieces can also be optimized.

### SUMMARY OF THE INVENTION

This object is achieved in the case of a machine tool of the type described at the beginning by a wall that defines the working space being provided with an opening, by the handling device being disposed on a side of the opening that is remote from the working space and by it being possible to use the handling device to insert workpieces into the work spindle and/or remove them from it through the opening.

The solution according to the invention can be regarded as advantageous in that locating the handling device outside the working space provides the opportunity on the one hand to place workpieces in the workpiece spindle and remove them from it, in each case with good accessibility, and on the other hand to carry out all of the handling outside the working space, in order in this way to minimize the disruption to the machining of the workpieces in the working space, so that overall nonproductive time is reduced.

It is also advantageous that the accessibility to the working space of the machine tool for setting-up, adjusting and servicing work can be improved.

A particularly advantageous solution provides that the opening lies on the same side of the spindle axis as the base of at least one machining unit, the machining unit being connected to the machine bed by said base.

Such a solution has the advantage that the opening lies on a side of the spindle axis on which no tools extend and from which no access to the working space is required to set up tools and machining units. That is to say that, by locating the opening in this way, a region of the working space that is not required either for supply of the tools or for adjusting the tools and for access when adjusting the tools, is used for inserting or removing workpieces.

This also allows particularly good observation of procedures, for example the insertion and removal of workpieces and the production processes in the machine tool.

It is particularly advantageous if the opening is disposed on the same side of the spindle axis as a displacement unit for at least one of the machining units, the displacement unit being connected to the machine bed.

As an alternative or in addition to the solution described so far, the object set out at the beginning is achieved in the case of a machine tool of the type stated at the beginning by a handling space being disposed to one side of a machine bed region that carries a least one of the machining units, said side being remote from the working space.

The advantage of this solution is the separation of the handling space and the working space by the machine bed region, so that also in this solution the working space is accessed from the handling space in a region of the working space that is generally not required for tools or for setting up tools and machining units.

It is particularly advantageous in this respect if the machine bed region carries a plurality of the machining units.

A particularly advantageous solution provides that at least one of the machining units is mounted on the machine bed region on a displacement unit in such a way as to be movable in relation to said region.

In this way, the handling device is likewise used to access a region of the working space that is generally not affected by tools or other devices.

In principle, in this solution the machine bed region may be disposed in such a way that the handling device accesses the working space laterally with respect to the machine bed region or around a side of the machine bed region.

However, it is particularly suitable if the machine bed region is provided with an opening, so that the handling device can likewise reach through the opening in the machine bed region.

With regard to the way in which the opening is disposed, it is particularly advantageous if the opening lies between different bases of machining units.

As an alternative or in addition to the solutions described so far, a further advantageous solution for achieving the object according to the invention, on the basis of a machine tool of the type described at the beginning, provides that the handling device is disposed on a side of the spindle axis that is remote from a front side of the working space and outside the working space and that the handling device reaches into the working space from the handling space in order to insert workpieces W into the work spindle or remove them from it.

To protect the handling space, a wall with an opening is suitably provided between said handling space and the working space.

To avoid the spread of swarf and coolant in the direction of the handling device during the machining of the workpieces in the working space, it is preferably provided that the opening can be closed by a door.

A particularly stable construction of the machine tool according to the invention is obtained if the handling space is at least partially surrounded by a stabilizing frame of the machine frame. A stabilizing frame of this type gives the machine frame increased stability, and in particular increased stiffness, and can be used for example to carry the handling device itself, and in particular also to accommodate the handling space for the handling device in a suitably space-saving way.

It is particularly advantageous if the stabilizing frame engages a machine bed body, in order to give the latter increased stiffness.

Furthermore, it is advantageous if the stabilizing frame rises up from a foot of the machine frame, so that there is a stable connection with the frame foot.

Furthermore, the stabilizing frame is advantageously formed in such a way that it substantially encloses the handling space, so that on the one hand a stable and stiff construction of the machine frame is possible and on the other hand the space enclosed by the stabilizing frame can be used in a simple and advantageous way for the handling space.

The stabilizing frame and the machine bed body may in principle be parts that are separate, but for example connected to each other. It is particularly advantageous, however, if the stabilizing frame and the machine bed body form a one-piece part, so that in such a case the machine bed also encloses the stabilizing frame.

To be able to handle the workpieces as advantageously as possible, it is preferably provided that the workpieces can be moved between the handling space and the working space in approximately parallel alignment with the spindle axis, in order to allow the transporting of the workpieces between the working space and the handling space to be performed as quickly as possible and with the fewest possible movements of the workpiece.

It is particularly advantageous here if the workpieces can be moved through the opening in approximately parallel alignment with the spindle axis.

To allow the workpieces also to be handled as easily as possible in the handling space, it is preferably provided that the workpieces can be handled by the handling device in the handling space in approximately parallel alignment with the spindle axis.

Here, an advantageous solution provides that the workpieces can be supplied in a workpiece magazine, or can be picked up from it, in approximately parallel alignment with the spindle axis.

As an alternative to this, it is conceivable for the workpieces to be supplied in a feeding device, or to be picked up from it, in approximately parallel alignment with the spindle axis.

To allow the times for the actual machining of each of the workpieces to be further optimized, a preparatory machining station is suitably provided on the machine frame.

This machining station may in principle be disposed on the machine bed body. A particularly suitable solution envisages disposing the machining station on the stabilizing frame, in order to optimize the required installation space as much as possible.

It is suitably provided that the workpieces can be machined in the preparatory machining station in approximately parallel alignment with the spindle axis.

In particular, it is advantageous in this respect when machining shaft parts if the preparatory machining station is a centering and cutting-to-length station.

Furthermore, it is likewise advantageous for reasons of space if the preparatory machining station is disposed outside a first machine bed body.

In the simplest case, the preparatory machining station can be disposed on the stabilizing frame.

To allow the handling device also to be used for loading the preparatory machining station, it is preferably provided that the preparatory machining station lies in the field of action of the handling device.

It is particularly advantageous with regard to the swarf and cooling lubricant produced by the preparatory machining station if the preparatory machining station is disposed outside the handling space.

In this case, it is suitably provided that the preparatory machining station is accessible from the handling space, the accessibility preferably being provided by way of a hole or opening in a second machine bed body for the preparatory machining station.

This opening in the second machine bed body is preferably also formed in such a way that the workpieces can be moved through it in approximately parallel alignment with the spindle axis.

The second machine bed body may in this case be an independent body.

An advantageous solution provides that the second machine bed body is also enclosed by the stabilizing frame for the first machine bed body.

With regard to the form of the handling device, nothing more specific has been stated in the explanation so far of the individual exemplary embodiments. Thus an advantageous solution provides that the handling device comprises a multiple gripper.

In addition, an advantageous exemplary embodiment of a handling device according to the invention provides that it comprises a swivel-arm robot.

The swivel-arm robot is formed for example in such a way that it has a foot, a bearing head, which is rotatable about an axis with respect to the foot, and an articulated arm, which is mounted on the bearing head. The articulated arm has a first swivel arm, swivel-mounted on the bearing head about a first swivel axis, and a second swivel arm, disposed at an end remote from the bearing head and able to swivel about a second axis.

Further features and advantages of the solution according to the invention are the subject of the following description and the pictorial representation of some exemplary embodiments.

### BRIEF DESCRIPTION OF THE DRAWINGS

FIG. 1 shows a perspective front view of a first exemplary embodiment of a machine tool according to the invention;

FIG. 2 shows a perspective view from behind of the first exemplary embodiment of the machine tool according to the invention;

FIG. 3 shows a section along line 3-3 in FIG. 2;

FIG. 4 shows a perspective view similar to FIG. 1 when the workpiece is being changed by a handling device according to the invention;

FIG. 5 shows a view corresponding to FIG. 2 when the workpiece is being changed;

FIG. 6 shows a view corresponding to FIG. 3 when the workpiece is being changed;

FIG. 7 shows a view corresponding to FIG. 2 during preparatory machining of the workpiece;

FIG. 8 shows a section corresponding to FIG. 3 during the preparatory machining of the workpiece;

FIG. 9 shows a view similar to FIG. 1 of a second exemplary embodiment of a machine tool according to the invention;

FIG. 10 shows a perspective front view of a third exemplary embodiment of a machine tool according to the invention;

FIG. 11 shows a perspective view from behind of the third exemplary embodiment of the machine tool according to the invention;

FIG. 12 shows a section along line 12-12 in FIG. 10 and

FIG. 13 shows a view corresponding to FIG. 11 when a workpiece is being picked up by the handling device.

### DETAILED DESCRIPTION OF THE INVENTION

A first exemplary embodiment of a machine tool according to the invention comprises a machine frame, designated overall by 10, with a frame foot 12, a swarf collector 14 and a first machine bed body 16, which rises up above the frame foot 12, is disposed adjacent a working space 18 and is connected, on a side remote from the working space 18, to the frame foot 12 by means of a stabilizing frame 20. In the case of the exemplary embodiment represented, the machine bed body 16 and the stabilizing frame 20 are a one-piece part and together form a machine bed.

The working space 18 is accessible on its front side 19, the side opposite from the machine bed body 16, preferably through a door in a working space enclosure that is not represented in the drawing.

In this case, the first machine bed body 16 preferably extends from the frame foot 12 transversely with respect to a standing area 22 for the machine frame 10, to be precise above the swarf collector 14. In this respect, the first machine bed body 16 may also be inclined by up to 45° with respect to the vertical, it being particularly advantageous if the inclination of the first machine bed body 16 with respect to the vertical line is as little as possible, that is to say as far as possible less than 30°, even better less than 15°.

In the simplest case, the first machine bed body 16 is formed in a way similar to a plate and carries a series of machining units on its side 24 facing the working space 18.

One of the machining units is for example a work spindle 30, which is mounted in a spindle housing 32 in such a way as to be rotatable by a drive that is not represented in the drawing.

In the case of this exemplary embodiment, the spindle housing 32 is mounted by a housing base 34 directly and fixedly on the first machine bed body 16, but it is also conceivable for the spindle housing 32 to be disposed movably in relation to the first machine body 16 by means of a slide system.

The work spindle 30 is rotatable about a spindle axis 36, which runs approximately parallel to the first machine bed body 16, and, in the case of the represented first exemplary embodiment of a machine tool, a tailstock 40 is provided coaxially with respect to the work spindle 30 as a further machining unit, the tailstock housing 42 being mounted with its housing base 44 on a Z slide 46, which is displaceable parallel to the spindle axis 36 and can be made to travel in relation to the first machine bed body 16 in the Z direction, that is to say parallel to the spindle axis 36, the Z slide 46 being guided on Z-slide guides 48, which are disposed directly on the first machine bed body 16.

Also disposed on the first machine bed body 16 are a first tool carrier 50 and a second tool carrier 60, which are formed for example as tool turrets and respectively comprise a turret housing 52 and 62, said housing being respectively mounted by its turret housing base 54 and 64 on a compound slide system 56 and 66, which for its part is respectively guided by slide guides 58 and 68 on the first machine bed body 16.

In the case of the compound slide systems 56 and 66, the slide guides 58 and 68 are preferably guides running in the Z direction.

As an alternative to this, however, instead of the compound slide systems 56 and 66, it is also conceivable to provide simple slide systems, which merely allow a movement of the respective tool carrier 50 or 60 in the X direction, that is to say transversely with respect to the Z direction. In this case, the corresponding slide guides are then mounted on the first machine body 16 in such a way that they merely run in the X direction.

In the case of the compound slide systems 56, 66 that are provided in the case of the first exemplary embodiment, the respective turret housing base 54 and 64 is then also mounted on an X slide and can be moved with respect to a Z slide 59 and 69 of the respective compound slide system 56 and 66.

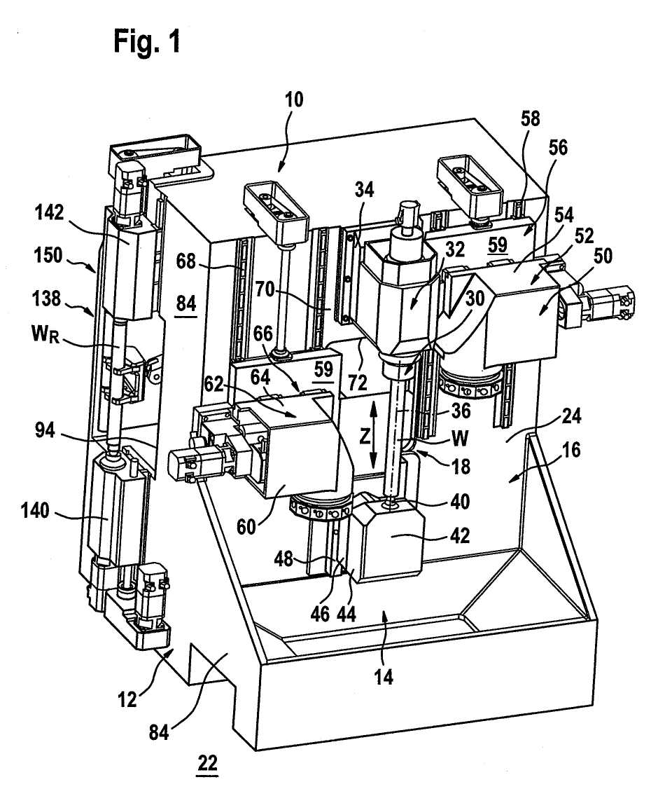

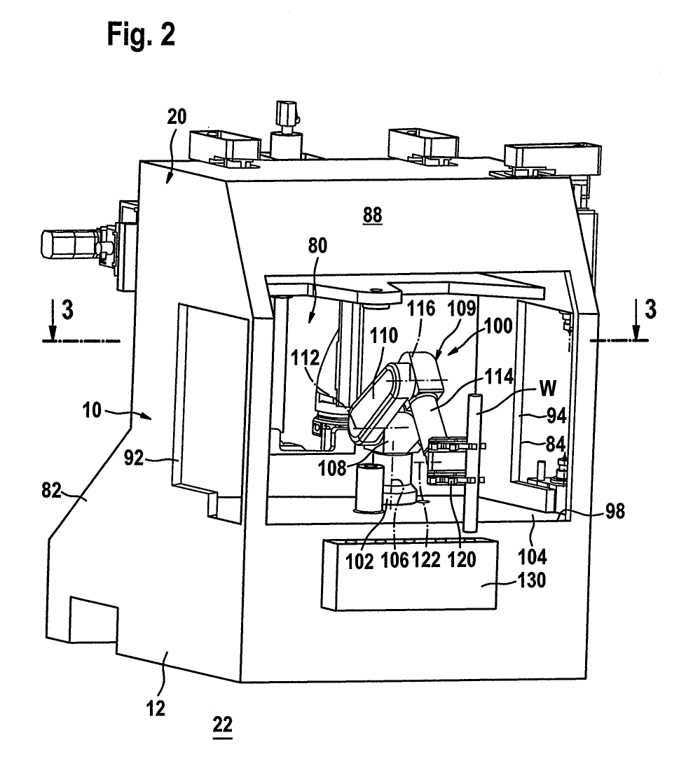

In the case of the first exemplary embodiment of the machine tool according to the invention, in a region 70 which lies on the one hand between the slide guides 58 and 68 of the compound slide systems 56, 66 and on the other hand between the Z slide 46 for the tailstock 40 and the housing base 34 of the work spindle 30, the machine bed body 16 is provided with an opening 72, which, as represented in FIGS. 1 and 2, allows a workpiece to be fed in from a handling space 80, which lies on a side of the first machine bed body 16 that is remote from the working space 18.

The handling space 80 is in this case partially enclosed by the stabilising frame 20, which extends substantially on a rear side of the first machine bed body 16 that is remote from the working space 18 and, as represented in FIGS. 1 to 3, thereby comprises side panels 82, 84, which extend transversely with respect to the first machine bed body 16 and extend from the frame foot 12 to the upper end panel 86, which on the one hand connects the side panels 82 and 84 as well as the first machine bed body 16 to one another respectively in an upper region remote from the frame foot 12.

The stabilising frame 20 preferably also comprises a rear wall 88, which connects the two side panels 82 and 84 at a distance from the first machine bed body 16, extends from the upper end panel 86 to the frame foot 12 and also additionally connects the side panels 82 and 84 to each other.

The handling space 80 is consequently preferably at least partly enclosed by the stabilising frame 20, not only the side panels 82 and 84 being provided with openings 92 and 94 but also the rear wall 88 being provided with a rear opening 98, to provide easy access to the handling space 80.

Provided in the handling space 80 is a handling device, which is designated overall by 100 and is formed for example as a swivel-arm robot. The handling device 100 may, however, also be formed as any other kind of robot.

In the case represented by way of example, the handling device 100 formed as a swivel-arm robot comprises a foot 102, which is mounted fixedly on the machine frame 10, for example on a device base 104 provided on the machine frame 10.

A bearing head 108 with an articulated arm 109 is mounted on this foot 102 in such a way that it can be rotated about a swivel axis 106, which for example runs approximately vertically. The articulated arm 109 comprises a first swivel arm 110, which is swivel-mounted about a substantially horizontal swivel axis 112 running transversely with respect to the swivel axis 106.

The first swivel arm 110 carries at its end opposite from the swivel axis 112 a second swivel arm 114, which can be swiveled with respect to the first swivel arm 110 about a swivel axis 116, which preferably runs approximately parallel to the swivel axis 112.

Furthermore, a gripping device 120 for the workpieces W is also mounted on the second swivel arm 114 and can be pivoted in relation to the second swivel arm 114 about a swivel axis 122, the swivel axis 122 for example likewise running approximately parallel to the swivel axis 116 and to the swivel axis 112.

Depending on the form of the swivel-arm robot 100, a swivel bearing 124, comprising the swivel axis 122, may also be able to swivel about an axis 126, which runs transversely with respect to the swivel axis 122 and transversely with respect to the swivel axis 116.

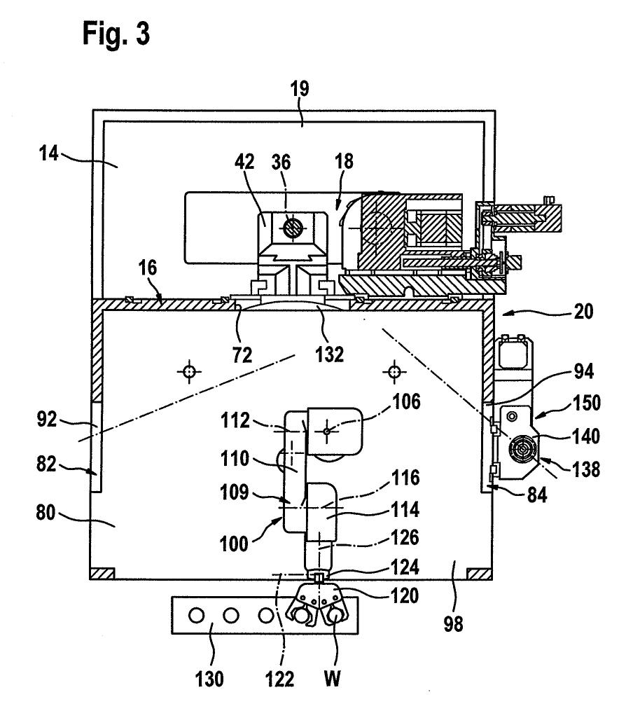

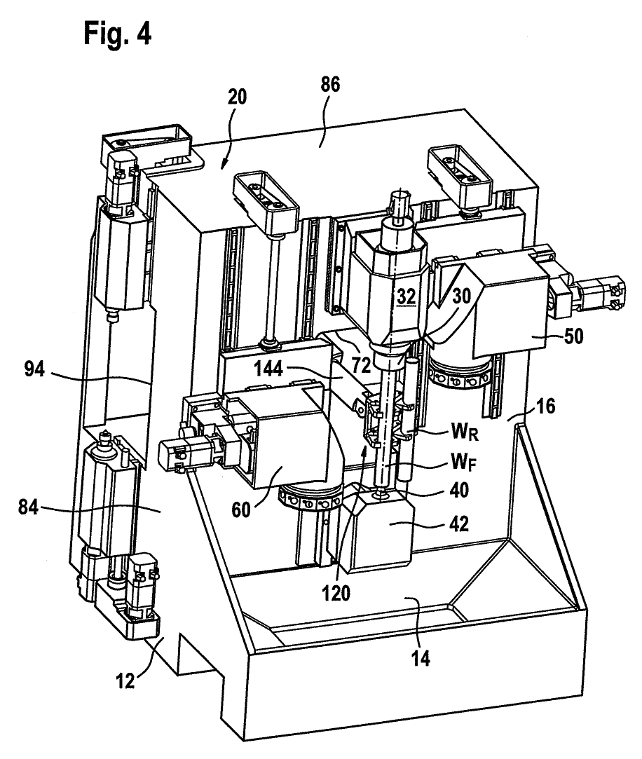

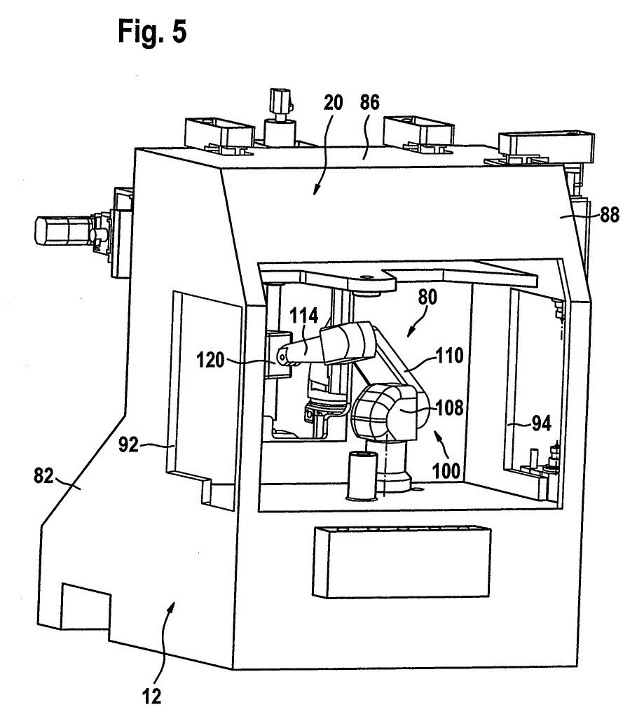

As represented in FIGS. 2 and 3 as well as in FIGS. 4 and 5, there is the possibility of using the handling device 100 to take workpieces W from a workpiece magazine 130, which is provided on the machine frame 10, and insert them into the work spindle 30 for machining, said workpieces also being accommodated for example by means of the tailstock 40. At the same time, there is the possibility of using the gripping device 120 to take out of the work spindle 30 a workpiece W_{F} on which machining has been completed and replace it with a blank workpiece W_{R}.

In this case, the handling device 100 reaches through the opening 72 in the first machine bed body 16, which for this is disposed in such a way that a perpendicular projection of the spindle axis 36 onto the opening 72 lies approximately at the center of the opening.

As an alternative to the provision of a workpiece magazine, there is the possibility of providing all conceivable workpiece-magazine or work-feeding and work-removing devices, such as for example linking belts, pallet racks, etc.

Locating the handling space 80 on a side of the first machine bed body 16 that is opposite from the working space 18 and providing the opening 72 in the first machine bed body 16 makes it possible in a simple way to insert workpieces W into the work spindle 30 for machining in the spindle and/or remove them from the spindle, without large travelling movements of the tool carriers 50 and 60 being necessary to create the required space for the insertion and removal of workpieces W into and from the work spindle 30.

Furthermore, there is adequate space available in the handling space 80 for depositing the workpiece W_{F} on which machining has been completed and picking up a blank workpiece W_{R}, space which can be used without adversely affecting further machining of a workpiece W held in the work spindle 30.

In particular, for machining the workpiece W in the workpiece spindle 30, the opening 72 can be closed by a door 132, in order to prevent the handling space 80 from being contaminated with swarf and coolant.

In particular whenever the workpieces W are shaft parts, separate centering and cutting to length of the same outside the first working space 18 is preferably also possible, as represented in FIG. 1, by providing a second working space 138 in the region of the side panel 84, in which space two centering and cutting-to-length units 140, 142 lying opposite each other are provided, disposed on opposite sides of the opening 94, it being possible for the blank workpiece W_{R} to be inserted with an alignment parallel to the spindle axis 36 through the opening 94 and between the centering and cutting-to-length units 140, 142, which can then both be moved in the direction of the blank workpiece W_{R}, in order to make the centering bores in it and correspondingly cut it to length. As an alternative to this, it is also possible in the case of stationary centering and cutting-to-length units to use the handling device 100 to move the workpiece W_{R} in relation to said units.

In this case, the side panel 84 represents a second machine bed body for a centering and cutting-to-length station designated overall by 150.

In the case of use of the centering and cutting-to-length station 150, consequently a blank workpiece W_{R} is picked up from the workpiece magazine 130, first inserted through the opening 94 into the centering and cutting-to-length station 150, where it is provided with centering bores and reduced to an intended length by the centering and cutting-to-length units 140 and 142. After the door 132 has been opened, the blank workpiece W_{R} provided with centering bores and cut to length is subsequently moved by the handling device 100 through the opening 72 into the first working space 18 and inserted there into the work spindle 30 after removal of a workpiece W_{F}, on which machining has been completed, from the work spindle 30. After insertion of the blank workpiece W_{R}, the gripping device 120 is moved into the handling space 80, once again through the opening 72, and, after the door 132 has been closed, machining of the workpiece W_{R} is performed in this first working space 18. During this time, the handling device 100 can deposit the workpiece W_{F}, on which machining has been completed, in the workpiece magazine 130, after that or at the same time once again grip a blank workpiece W_{R} and insert it into the centering and cutting-to-length station 150, in order once again to make the centering bores in the new blank workpiece W_{R} and correspondingly cut it to length.

After the blank workpiece W_{R} has been centered and cut to length, it can be kept ready for insertion into the first working space 18 and take the place of the workpiece W held in the work spindle 30 once machining on this workpiece has been completed.

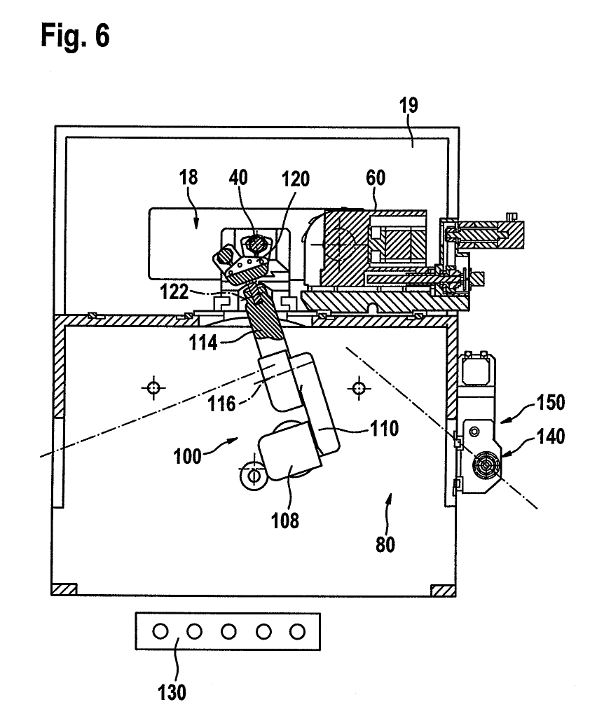

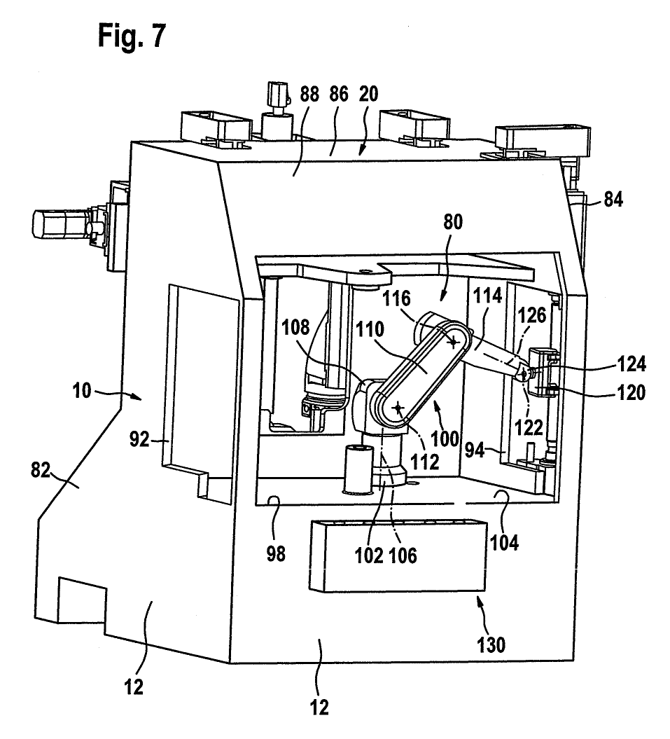

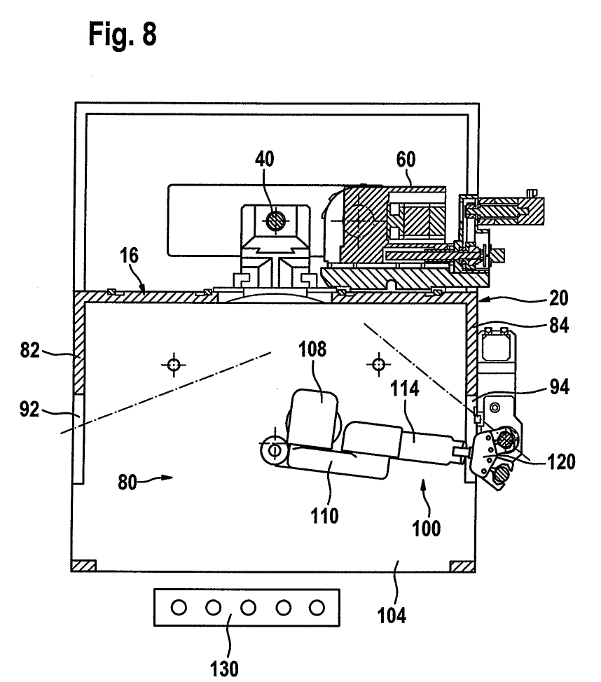

In the case of the first exemplary embodiment, represented in FIGS. 1 to 8, the spindle axis 36 runs substantially vertically and the blank workpieces W_{R} are likewise aligned substantially vertically in the centering and cutting-to-length station 150, and furthermore the vertical alignment of the workpieces W is also retained in the workpiece magazine 130, so that altogether the alignment of the workpieces W is retained in all handling procedures performed by the handling device 100.

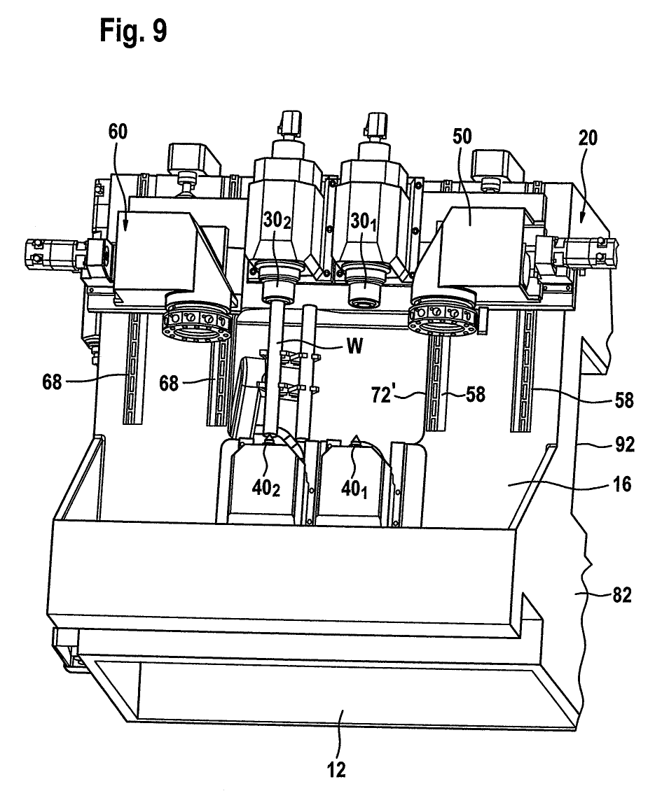

By contrast with the first exemplary embodiment, represented in FIGS. 1 to 8, in the case of a second exemplary embodiment, represented in FIG. 9, two work spindles 30₁ and 30₂ as well as two tailstocks 40₁ and 40₂ are provided instead of one work spindle 30 and one tailstock 40, so that two workpieces W can be machined at the same time, the tool carrier 50 being associated with the work spindle 30₁ and the tailstock 40₁, while the tool carrier 60 is associated with the work spindle 30₂ and the tailstock 40₂, so that in this case only the tools of one of the tool carriers 50 and 60 can be respectively used on each of the workpieces W in one of the work spindles 30₁ and 30₂.

In this case, the opening 72′ extends over substantially the entire interspace between the slide guides 58 and 68, so that access to both work spindles 30₁ and 30₂ is possible for the gripping device 120 in a simple way, in order to insert workpieces W into both or remove them from both.

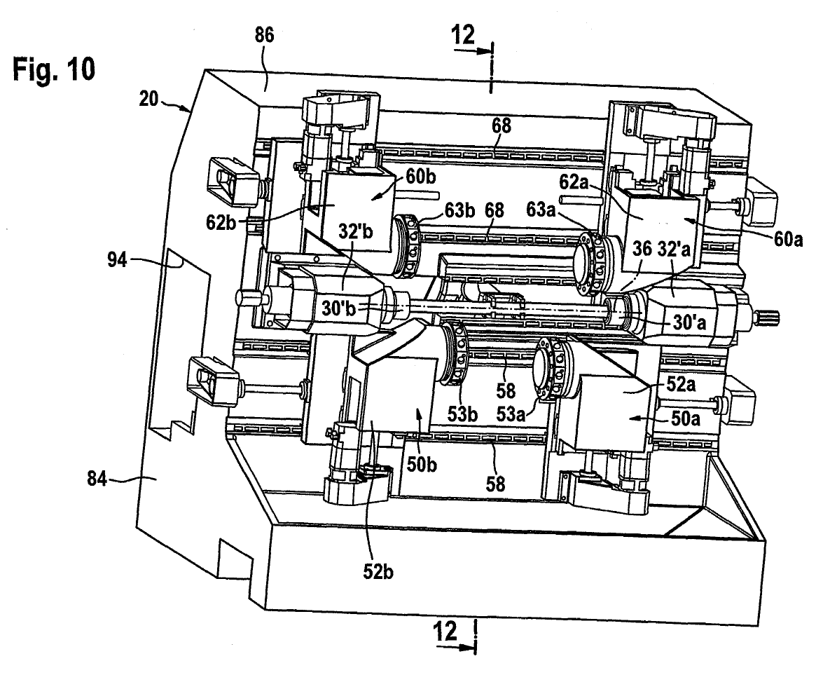

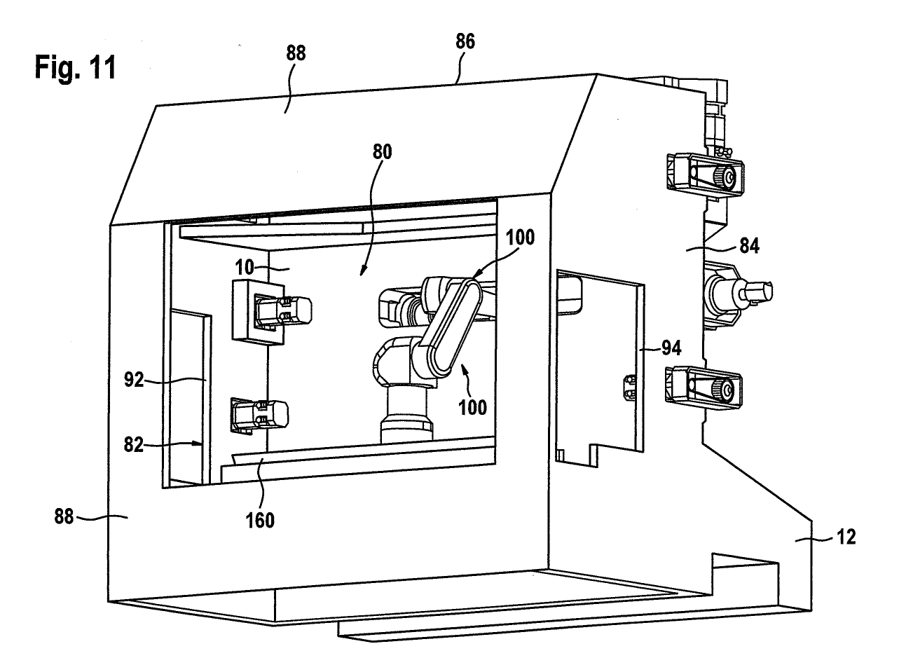

In the case of a third exemplary embodiment of a machine tool according to the invention, represented in FIGS. 10 to 13, the parts that are identical to those of the preceding exemplary embodiments are provided with the same reference numerals, so that reference can be made in full to the statements made in relation to these exemplary embodiments.

By contrast with the preceding exemplary embodiments, in the third exemplary embodiment it is not the case that one work spindle 30 and one tailstock 40 are provided but that two work spindles 30′a and 30′b are provided, lying opposite each other, aligned coaxially with respect to one another and also consequently coaxially with respect to the spindle axis 36, the spindle axis 36 being aligned approximately horizontally in the case of this exemplary embodiment.

Slide guides 58 and 68 are provided on both sides of the spindle axis 36, two first tool carriers 50a and 50b being provided on the slide guides 58, while two second tool carriers 60a and 60b are provided on the slide guides 68, the turret housings 52a and 52b or 62a and 62b associated with the tool carriers 50a and 50b or 60a and 60b that are disposed on the same slide guides 58, 68 respectively carrying turrets 53a and 53b or 63a and 63b, which are respectively disposed on sides of the turret housings 52a and 52b or 62a and 62b that face each other.

This provides the possibility of using the tools of the two tool turrets 53a and 53b or 63a and 63b that can respectively be used at the same time on the workpiece W, which is mounted by the two tool spindles 30′a and 30′b.

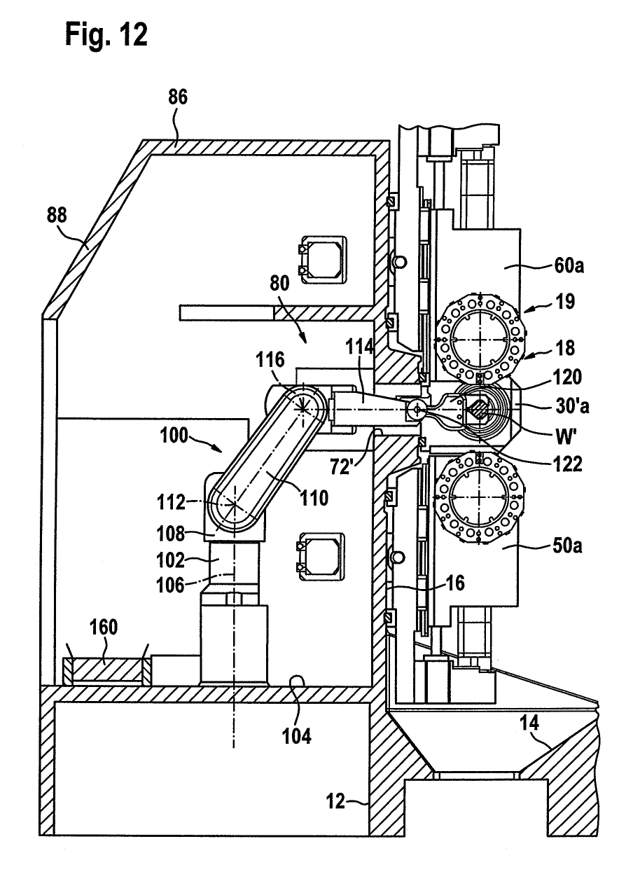

As represented in particular in FIG. 12, the opening 72′ likewise lies between the slide guides 58 and 68, in order to obtain optimum access to the working space 18 from the handling space 80.

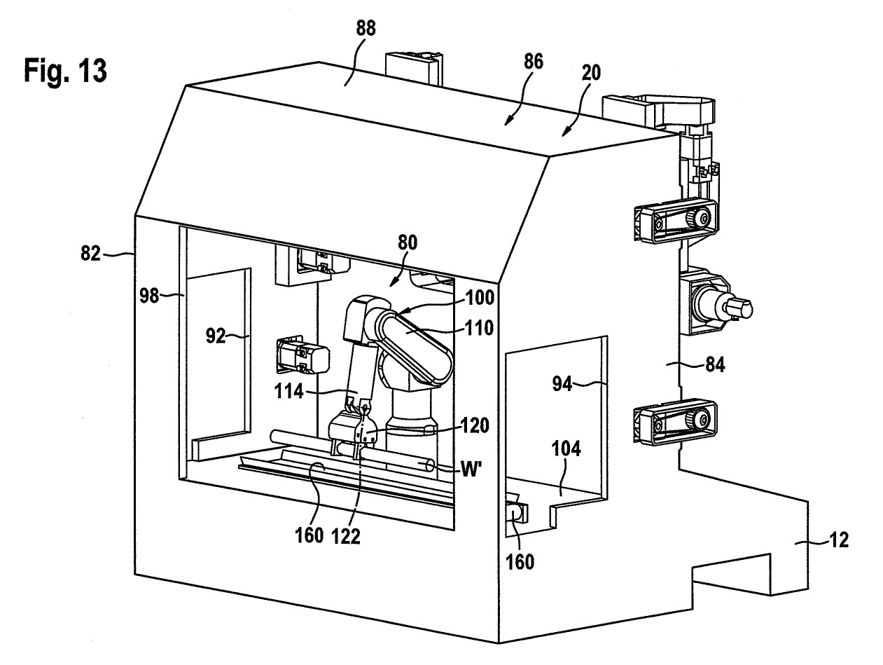

In the same way as described in connection with the preceding exemplary embodiments, provided in the handling space 80 is the handling device 100, which is likewise represented by way of example as a swivel-arm robot and, as represented in particular in FIG. 13, is capable of picking up the workpieces W′ in substantially horizontal alignment from a feeding device 160 and introducing them from the handling space 80 into the working space 18 via the opening 72′, in order then to insert these workpieces W′ into the two work spindles 30′a and 30′b for machining.

At the same time, the gripping device 120 provides the possibility of first removing a workpiece on which machining has been completed from the work spindles 30′a and 30′b and then inserting a blank workpiece W′_{R} into the work spindles 30′a and 30′b, without having to move back again into the handling space 80. Only after this insertion of the blank workpiece W′_{R} between the work spindles 30′a and 30′b does the handling device 100 move the work-gripping device 120 back into the handling space 80, in order to deposit in the latter the workpiece W′_{F} on which machining has been completed, likewise on the feeding device 160, which then also at the same time performs the removal of the workpiece W′_{F} on which machining has been completed.

1. Machine tool comprising
a machine frame with a machine bed, machining units mounted on the machine bed, of which at least one is a work spindle for a workpiece to be machined and at least one is a tool carrier, displacement units, by which the at least one work spindle and the at least one tool carrier can be moved relative to one another within a working space for machining the workpiece,
and a handling device, by which workpieces can be inserted into and removed from the work spindle,
a wall defining the working space said wall being is provided with an opening, the handling device being disposed on a side of the opening that is remote from the working space and in that it is possible to use the handling device to insert workpieces into the work spindle and/or remove them from it through the opening.

2. Machine tool according to claim 1, wherein the opening lies on the same side of the spindle axis as the base of at least one machining unit, the machining unit being connected to the machine bed by said base.

3. Machine tool according to claim 1, wherein the opening is disposed on the same side of the spindle axis as a displacement unit for at least one of the machining units, the displacement unit being connected to the machine bed.

4. Machine tool comprising
a machine frame with a machine bed, machining units mounted on the machine bed, of which at least one is a work spindle for a workpiece to be machined and at least one is a tool carrier, displacement units, by which the at least one work spindle and the at least one tool carrier can be moved relative to one another within a working space for machining the workpiece,
and a handling device, by which workpieces can be inserted into and removed from the work spindle,
a handling space being disposed to one side of a machine bed region that carries at least one of the machining units, said side being remote from the working space.

5. Machine tool according to claim 4, wherein the machine bed region carries a plurality of the machining units.

6. Machine tool according to claim 4, wherein at least one of the machining units is mounted on the machine bed region by a displacement unit in such a way as to be movable in relation to said region.

7. Machine tool according to claim 5, wherein the machine bed region is provided with an opening.

8. Machine tool according to claim 2, wherein the opening lies between different bases of machining units.

9. Machine tool comprising
a machine frame with a machine bed, machining units mounted on the machine bed, of which at least one is a work spindle for a workpiece to be machined and at least one is a tool carrier, displacement units, by which the at least one work spindle and the at least one tool carrier can be moved relative to one another within a working space for machining the workpiece,
and a handling device, by which workpieces can be inserted into and removed from the work spindle,
the handling device being disposed on a side of the spindle axis that is remote from a front side of the working space and outside the working space and in that the handling device reaches into the working space from the handling space in order to insert workpieces into the work spindle or remove them from it.

10. Machine tool according to claim 9, wherein a wall with an opening is provided between the handling space and the working space.

11. Machine tool according to claim 1, wherein the opening can be closed by a door.

12. Machine tool according to claim 1, wherein the handling space is at least partially surrounded by a stabilizing frame of the machine frame.

13. Machine tool according to claim 12, wherein the stabilizing frame engages a machine bed body of the machine bed.

14. Machine tool according to claim 12, wherein the stabilizing frame substantially encloses the handling space.

15. Machine tool according to claim 1, wherein the workpieces can be moved between the handling space and the working space in approximately parallel alignment with the spindle axis.

16. Machine tool according to claim 15, wherein the workpieces can be moved through the opening in approximately parallel alignment with the spindle axis.

17. Machine tool according to claim 15, wherein the workpieces can be handled by the handling device in the handling space in approximately parallel alignment with the spindle axis.

18. Machine tool according to claim 15, wherein the workpieces can be supplied in a workpiece magazine in approximately parallel alignment with the spindle axis.

19. Machine tool according to claim 15, wherein the workpieces can be supplied in a feed device in approximately parallel alignment with the spindle axis.

20. Machine tool according to claim 1, wherein a preparatory machining station is provided on the machine frame.

21. Machine tool according to claim 20, wherein the workpieces can be machined in the preparatory machining station in approximately parallel alignment with the spindle axis.

22. Machine tool according to claim 20, wherein the preparatory machining station is a centering and cutting-to-length station.

23. Machine tool according to claim 20, wherein the preparatory machining station is disposed outside a first machine bed body.

24. Machine tool according to claim 23, wherein the preparatory machining station is disposed on the stabilizing frame.

25. Machine tool according to claim 20, wherein the preparatory machining station lies in the field of action of the handling device.

26. Machine tool according to claim 20, wherein the preparatory machining station is disposed outside the handling space.

27. Machine tool according to claim 25, wherein the preparatory machining station is accessible from the handling space.

28. Machine tool according to claim 27, wherein a machine bed body provided for the preparatory machining station has an opening.

29. Machine tool according to claim 28, wherein the workpieces can be moved through the opening in approximately parallel alignment with the spindle axis.

30. Machine tool according to claim 1, wherein the handling device comprises a multiple gripper.

31. Machine tool according to claim 1, wherein the handling device comprises a swivel-arm robot.

32. Machine tool according to claim 31, wherein the swivel-arm robot has a foot, a bearing head, which is rotatable about an axis with respect to the foot, and an articulated arm, which is mounted on the bearing head.

33. Machine tool according to claim 32, wherein the articulated arm has a first swivel arm, swivel-mounted about a first swivel axis with respect to the bearing head, and a second swivel arm, disposed at an end remote from the bearing head and able to swivel about a second swivel axis.
